(19) United States
(12) Patent Application Publication
(10) Pub. No.: US 2023/0198859 A1
(43) Pub. Date: Jun. 22, 2023

(54) FEDERATED NETWORK TOPOLOGY VISUALIZATION

(71) Applicant: VMware, Inc., Palo Alto, CA (US)

(72) Inventors: Shrinivas Sharad Parashar, Pune (IN); Tarang Khandelwal, Pune (IN)

(21) Appl. No.: 17/701,437

(22) Filed: Mar. 22, 2022

(30) Foreign Application Priority Data
Dec. 22, 2021 (IN) 202141059968

(51) Int. Cl. H04L 41/22; H04L 41/12

(52) U.S. Cl. CPC H04L 41/22; H04L 41/12

(57) ABSTRACT

Some embodiments of the invention provide a method for presenting a visualization of a logical network that spans multiple geographically dispersed sites. For each logical element in a set of logical elements of the logical network, the method identifies a set of sites spanned by the logical element. Through a user interface (UI), the method displays a visualization of a topology of the logical network, the visualization including (1) representations for the logical elements and for logical connections between the logical elements and (2) at least a first set of UI items specifying each site of the multiple sites spanned by the logical network to indicate, for each logical element represented in the visualization, the set of sites spanned by the logical element.

### BACKGROUD

Today, enterprise customers often rely on multiple sites and datacenters to ensure high availability of applications, to provide better application response times, and to provide the most cost-effective hosting solutions depending on application criticality. Additionally, some enterprise customers rely on these multiple sites and datacenters as a result of mergers and acquisitions. Multiple site support is an umbrella covering multiple use-cases, such as disaster-avoidance, disaster-recovery, and resource pooling. Some providers solve these use cases by providing a mechanism to stretch the network across all sites, or by having the consistent/same configuration across all the sites. However, network topology views typically only provide information about the network configuration at a single site, and therefore do not provide an adequate overview of the entire network.

### BRIEF SUMMARY

Some embodiments of the invention provide a method for presenting a visualization of a logical network that spans multiple geographically dispersed sites (e.g., datacenters located in London, New York, Los Angeles, etc.). The logical network includes multiple logical elements, each of which spans some or all of the sites spanned by the logical network. Through a user interface (UI), the method displays a visualization of a topology of the logical network, including representations for the logical elements and for logical connections between the logical elements. This visualization includes UI items specifying each site spanned by the logical network to indicate, for each logical element represented in the visualization, the set of sites spanned by the logical element.

In some embodiments, a first set of UI items specifying all of the sites is applied to a representation of a first portion of the logical network that spans all of the sites while a second set of UI items specifying a subset of the sites is applied to a representation of a second portion of the logical network that only spans this subset of sites. In some embodiments, in order to indicate which portions of the logical network span which sites, the entire logical network topology represented in the visualization is enclosed by a first shape (e.g., a first oval) while the second portion is enclosed by a second shape (e.g., a second oval) within the first shape. The first set of UI items are applied to the first shape (e.g., as badges along the border of the first shape) and the second set of UI items are applied to the second shape (e.g., as badges along the border of the second shape) to provide the appropriate indication as to which sites are spanned by the different portions of the logical network. Each portion of the logical network spanning a different subset of sites may be represented within a different shape within a different UI item. If a sub-portion of the second portion of the logical network spans fewer sites than the subset of sites specified by the second set of UI items, some embodiments represent this sub-portion within a third shape with a third set of UI items specifying this smaller set of sites.

The portion of the logical network represented within a smaller shape (e.g., the second portion of the logical network in the above example) logically connects to at least one logical element within the larger portion of the logical network in some embodiments. In some embodiments, the representation of the logical network’s topology is a tree structure and each sub-portion is represented as a subtree of that tree structure. If a logical network portion is fully isolated from the larger logical network, some embodiments treat this as a separate logical network that is separated in the UI visualization (or included in a separate UI visualization).

The UI items provided through the UI are selectable in some embodiments. Upon receiving a selection of one of the UI items that corresponds to a particular site in the multiple sites spanned by the logical network, in some embodiments, a location-specific topology of the logical network for the particular site is displayed through the UI. In some embodiments, the site corresponding to a selected UI item is spanned by the first portion of the logical network and not spanned by the second portion of the logical network. In some such embodiments, the location-specific topology displayed through the UI only includes the first portion of the logical network while excluding the second portion.

In some embodiments, a global network manager manages the global configuration for the logical network (e.g., receiving configuration data from administrators and defining the logical configuration for the network based on this configuration data), while local managers at each site spanned by the logical network manage local configurations for the sites. The global manager, in some embodiments, identifies the sites spanned by each logical network element and provides the logical configuration data for the network to the site. In addition, in some embodiments, the global manager uses this information to generate the logical network visualization.

Administrators, in some embodiments, may define configurations for sites at the local manager level that differ from configurations defined at the global manager (i.e., modifying the configuration for a particular logical network element as implemented within that site). In this case, the local manager provides the global manager with a notification of this change. In such cases where the global configuration is overridden by an administrator at a local manager for a specific site, the visualization displayed through the UI includes a UI item (e.g., a badge icon) at a logical element associated with that specific site. When this UI item is selected (e.g., by mouse click, cursor hovering, etc.), in some embodiments, a pop-up window is displayed that provides additional information on the configuration differences at the specific site.

The set of logical elements represented through the UI, in some embodiments, can include logical routers, logical switches, and compute nodes (e.g., virtual machines (VMs), containers, etc.). The compute nodes are end machines that logically connect to logical switches, which logically connect the end machines to each other and to gateway logical routers. The logical routers, in some embodiments, can include logical routers that are used to segregate different groups of logical switches (and provide different services to these different groups of logical switches) and logical routers that connect the logical network to external networks.

In some embodiments, when the number of logical elements in a set of logical elements logically connected to a single logical element (e.g., a set of compute nodes connected to a logical switch) exceeds a threshold, a group node is used to represent the set of logical elements in the visualization. The group node, in some embodiments, includes a UI item that indicates the number of logical elements represented by the group node. As such, when a set of compute nodes (or multiple sets of compute nodes) that logically connect to the same logical switch, regardless of the site to which the compute nodes are local, the set of compute nodes are represented as a group node, in some embodiments.

In some embodiments, when the group node represents sets of compute nodes at multiple sites spanned by the logical switch to which the compute nodes connect, selecting the group node causes the UI to expand the group node in the visualization by separating the sets of compute nodes by the site at which each set of compute nodes is located. For instance, if a group node represents three sets of compute nodes located at three different sites, the expanded group node will include one group node, or group of individual nodes (i.e., when the number of compute nodes at a site does not meet the threshold for being represented as a group node), for each of the three sites. These site-specific group nodes can also be selected for further expansion (e.g., to display representations of individual compute nodes), according to some embodiments.

The logical connections between representations of logical forwarding elements (e.g., logical switches and gateway logical routers) are also selectable through the UI in some embodiments. These connections can include interfaces between a logical router that connects logical elements of the logical network to external networks and a logical router that connects groups of logical switches as well as between either type of logical router and a logical switch.

When a selection of such an interface is received, some embodiments display a pop-up window is displayed through the UI. This pop-up window includes representations of the pair of logical forwarding elements associated with the selected interface, as well as one link between the representations of these logical forwarding elements for each site spanned by these logical forwarding elements, according to some embodiments. Each link in the pop-up window is shown with network addresses involved on ports from each end of the link.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a visualization of an overview of representations of two logical networks displayed through a UI, in some embodiments.

FIG. 2 illustrates a process performed to display a representation of a logical network through a UI, in some embodiments.

FIG. 3 illustrates a visualization displayed through a UI of a representation of a logical network that includes a sub-tree having a different span than the main portion of the logical network, in some embodiments.

FIG. 4 illustrates a visualization displayed through a UI, in some embodiments, of a representation of a logical network that includes two sub-tree spanning different subsets of the set of sites spanned by the rest of the logical network.

FIG. 5 illustrates a visualization displayed through a UI, in some embodiments, of a representation of a logical network that includes a second sub-portion within a first sub-portion of the logical network.

FIG. 6 illustrates a visualization displayed through a UI of a representation of a logical network for which the configuration has been overridden at a local manager of a particular site, in some embodiments.

FIG. 7 illustrates a visualization displayed through a UI of a representation of the logical network illustrated in FIG. 3 after a group node representing a group of VMs has been selected for expansion, in some embodiments.

FIG. 8 illustrates a process performed by the network visualization application, in some embodiments, to display a visualization of a logical network topology after a group node representing VMs local to more than one site has been selected.

FIG. 9 illustrates a visualization displayed through a UI of the representation of the logical network illustrated in FIG. 3 after an interface between two logical forwarding elements has been selected, in some embodiments.

FIG. 10 illustrates a process performed by the network visualization application, in some embodiments, upon receiving selection of an interface between representations of two logical forwarding elements.

FIG. 11 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for presenting a visualization of a logical network that spans multiple geographically dispersed sites (e.g., datacenters located in London, New York, Los Angeles, etc.). The logical network includes multiple logical elements, each of which spans some or all of the sites spanned by the logical network. Through a user interface (UI), the method displays a visualization of a topology of the logical network, including representations for the logical elements and for logical connections between the logical elements. This visualization includes UI items specifying each site spanned by the logical network to indicate, for each logical element represented in the visualization, the set of sites spanned by the logical element.

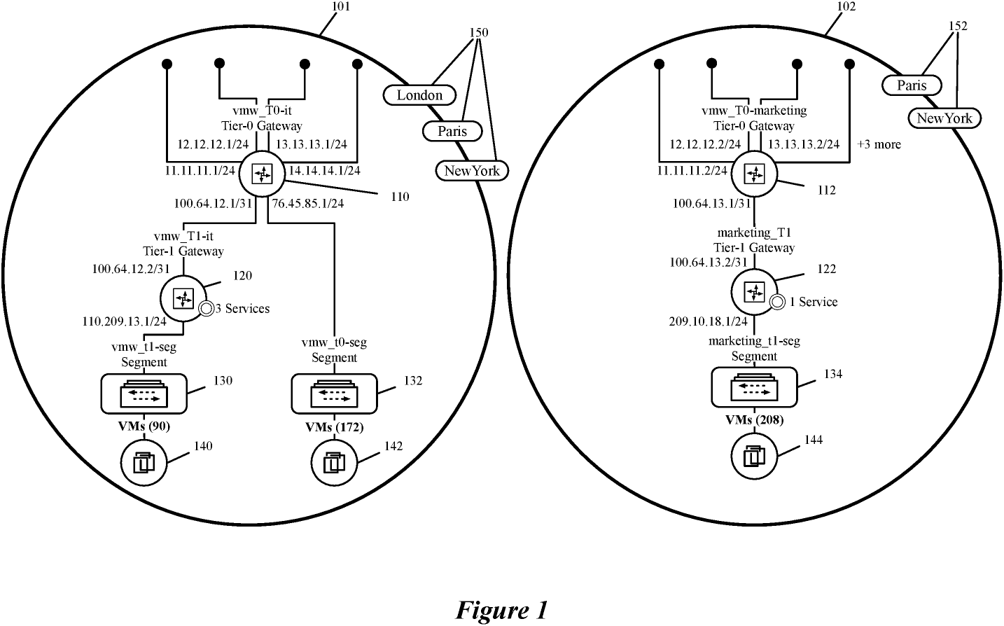

FIG. 1 illustrates a visualization of an overview of representations of two logical networks 101 and 102 displayed through a UI, in some embodiments. As shown, the representations of the logical networks 101 and 102 include representations of the logical elements of these logical networks arranged hierarchically in the UI. Each representation of a logical element shown in the UI represents one or more logical elements of a respective type, and are arranged within the hierarchy by type of logical element and based on logical network connections, with logical forwarding elements that connect logical elements of the logical network to external networks placed at the top of the hierarchy, end machines placed at the bottom of the hierarchy, and other logical forwarding elements in between to provide logical connections between the end machines and logical forwarding elements that connect to external networks.

The set of logical elements represented through the UI, in some embodiments, can include logical routers, logical switches, and compute nodes (e.g., virtual machines (VMs), containers, etc.). The compute nodes are end machines that logically connect to logical switches, which logically connect the end machines to each other and to gateway logical routers. The logical routers, in some embodiments, can include logical routers that are used to segregate different groups of logical switches (and provide different services to these different groups of logical switches) and logical routers that connect the logical network to external networks.

In some embodiments, each logical network endpoint connects to a logical switch, and each logical switch may have multiple connected endpoints. Most of the logical switches connect to a tier-1 logical router (each of which may have multiple connected logical switches), and most tier-1 logical routers connect to a tier-0 logical router (each of which may have multiple connected tier-1 logical routers). Additionally, logical switches can also connect to tier-0 logical routers (each of which may have multiple connected logical switches in addition to multiple connected tier-1 logical routers). Tier-0 logical routers, in some embodiments, are responsible for connecting the logical network to external networks (e.g., other tier-0 logical routers that provide connectivity to other logical networks, the Internet, etc.).

In this example, the representation of the logical network 101 includes VMs 140 (i.e., end machines) that logically connect to a logical switch 130 (also referred to as a segment). The logical switch 130 logically connects the VMs 140 to the tier-1 logical router 120, which provides a logical connection to the tier-0 logical router 110 that logically connects logical elements of the logical network 101 to external networks. The logical network 101 also includes VMs 142 that logically connect to the logical switch 132. Unlike the logical switch 130, the logical switch 132 does not logically connect the VMs 142 to a tier-1 logical router, but rather directly to the tier-0 logical router 110. Additionally, the badges 150 applied to the oval around the representation of the logical network 101 indicate that this logical network spans three sites—London, Paris, and New York, as shown.

The representation of the logical network 102 includes a logical switch 134 that logically connects VMs 144 to each other and to the tier-1 logical router 122. The tier-1 logical router 122 logically connects the logical switch 134 to the tier-0 logical router 112, which provides a logical connection to external networks. While the logical elements shown in the representation of the logical network 101 are illustrated as spanning three sites, the logical elements of the logical network 102 span two sites—Paris and New York—as indicated by the badges 152 applied to the oval encompassing the representation of the logical network 102.

In some embodiments, a group of logical elements is represented in the visualization as a group node. Group nodes are used, in some embodiments, when the number of logical elements in the group exceeds a threshold number. In some embodiments, the threshold number differs between different types logical elements. For instance, the threshold number for representing VMs as a group node is higher, in some embodiments, than the threshold number for representing logical switches as a group node. Additionally, each group node in the visualization includes a tag indicating the number of logical elements represented by the group node, and the type of logical element. For example, the representation of the logical network 101 includes two group nodes 140 and 142 representing a group of 90 VMs connected to the logical switch 130 and a group of 172 VMs logically connected to the logical switch 132, respectively, while the representation of the logical network 102 includes one group node 144 representing a group of 208 VMs logically connected to the logical switch 134.

In some embodiments, when one or more items representing logical elements and/or groups of logical elements of a first type (e.g., VMs) are logically connected to one or more logical elements in a group of logical elements of a second type (e.g., logical switches) that is higher in the hierarchy than the first type and that is represented by a group node, some embodiments group the one or more first-type logical elements using a single group node under the group node representing the second-type logical elements. In some embodiments, this is done irrespective of (i) whether the number of first-type logical elements exceeds a threshold number and (ii) whether the first-type logical elements all connect to the same second-type logical element (e.g., a group of VMs connected to different logical switches that are grouped together). In other words, when a group of parent nodes are represented as a single group node, in some embodiments, all of the child nodes of those parent nodes are also represented as a single group node under the parent group node.

The UI items provided through the UI, such as the badges 150 and 152, are selectable in some embodiments. As such, when one of the badges is selected (e.g., by a user via a mouse, trackpad, or other device), a location-specific topology of the logical network for the particular site is displayed through the UI. In some embodiments, when the location-specific topology of the logical network is displayed, the number of VMs represented by a group node may change based on the sites to which each of the VMs represented by the group node is local. For instance, if 100 of the 208 VMs represented by the group node 144 in the representation of the logical network 102 are local to the Paris site, while the other 108 VMs are local to the New York site, then the group node representing the VMs in a location-specific topology of the logical network for the Paris site would include a tag indicating the group node represents 100 VMs rather than the total 208 VMs.

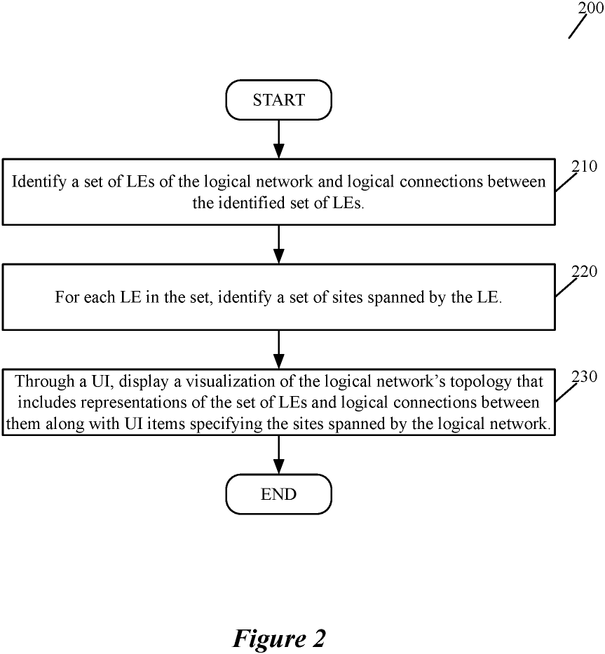

FIG. 2 illustrates a process performed to display a representation of a logical network through a UI, in some embodiments. The process 200, in some embodiments, is performed by a network visualization application. The process 200 starts by identifying (at 210) a set of logical elements of the logical network that is to be represented through a UI, and logical connections between the identified set of logical elements. Using the representation of the logical network 101 described above, for example, the network visualization application would identify the logical routers 110 and 120, the logical switches 130 and 132, the groups of VMs 140 and 142, and the logical connections between these logical elements.

For each logical element in the identified set of logical elements, the process identifies (at 220) a set of sites spanned by the logical element. For instance, the network visualization application would identify London, Paris, and New York as the sites spanned by the logical network 101. In some embodiments, different logical elements of a logical network span different sets of sites. For instance, a sub-portion of a logical network can span fewer sites than the rest of the logical network, in some embodiments, as will be further described below.

Once the logical elements, logical connections between them, and sites spanned by each logical element have been identified, the process then displays through a UI (at 230) a visualization of a representation of the logical network’s topology, including representations of the identified set of logical elements and logical connections between them, along with UI items specifying the sites spanned by the logical elements of the logical network. These UI items, in some embodiments, are badges applied to boundaries that encompass the representation of the logical network, such as the badges 150 applied to the oval that encompasses the representation of the logical network 101. Following 230, the process 200 ends.

As mentioned above, in some embodiments, a first set of UIitems (e.g., badges) specifying all of the sites spanned by logical elements of a logical network is applied to a representation of a first portion of the logical network, while a second set of UI items (e.g., badges) specifying a subset of the sites is applied to a representation of a second portion of the logical network that only spans this subset of sites. In some embodiments, in order to indicate which portions of the logical network span which sites, the entire logical network topology represented in the visualization is enclosed by a first shape (e.g., a first oval) while the second portion is enclosed by a second shape (e.g., a second oval) within the first shape. The first set of UI items are applied to the first shape (e.g., as badges along the border of the first shape) and the second set of UI items are applied to the second shape (e.g., as badges along the border of the second shape) to provide the appropriate indication as to which sites are spanned by the different portions of the logical network.

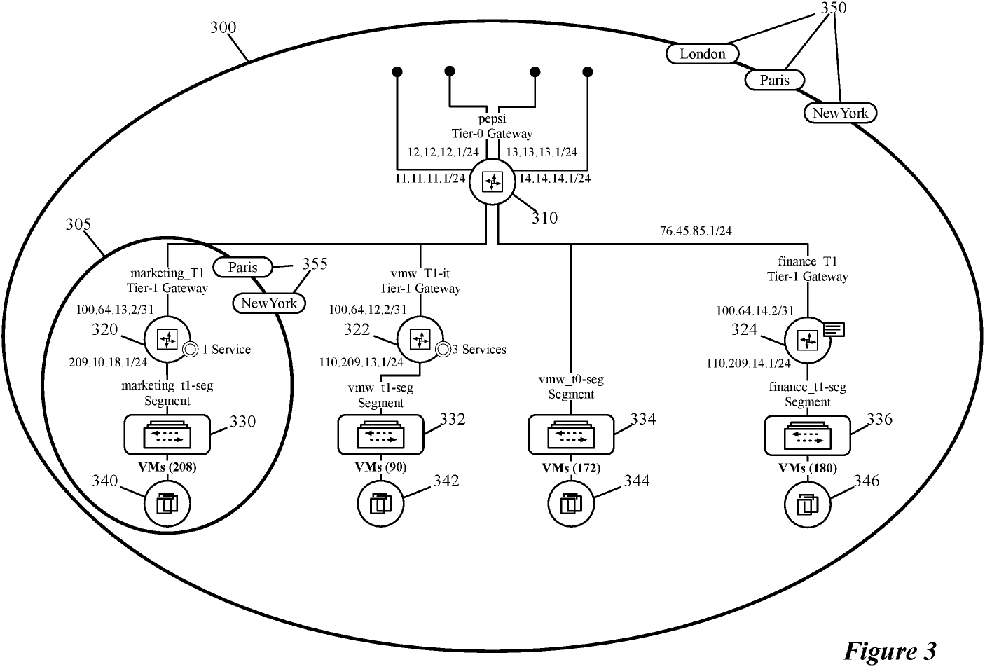

FIG. 3 illustrates a visualization displayed through a UI of a representation of a logical network that includes a sub-tree having a different span than the main portion of the logical network, in some embodiments. As shown, the representation of the logical network 300 includes a tier-0 logical router 310 for connecting the logical elements of the logical network to external networks.

A logical switch 330 logically connects a group of 208 VMs represented by group node 340 to each other and to a tier-1 logical router 320, which logically connects to the tier-0 logical router 310. Another logical switch 332 logically connects a group of 90 VMs represented by group node 342 to each other and to a tier-1 logical router 322, which also logically connects to the tier-0 logical router 310. A third logical switch 334 logically connects a group of 172 VMs represented by group node 344 to each other and directly to the tier-0 logical router 310. Lastly, a fourth logical switch 336 logically connects a group of 180 VMs represented by group node 346 to each other and to a tier-1 logical router 324, which, like the other tier-1 logical routers 320 and 322, logically connects to the tier-0 logical router 310.

As mentioned above, different portions of a logical network can span different sets and subsets of sites. In this example, a set of badges 350 are applied to the oval encompassing the representation of the logical network 300 and indicate that the logical network spans the London, Paris, and New York sites. Within the boundaries of the oval encompassing the representation of the logical network 300 is a second oval encompassing a sub-portion of the logical network 305 to indicate that the logical elements of this sub-portion have different spans than the rest of the logical network, as indicated by the badges 355 specifying this sub-portion spans only the Paris and New York sites, and not the London site. As a result, the site-specific representation of the topology for the London site would not include the logical elements of the sub-portion 305 that is within the second oval.

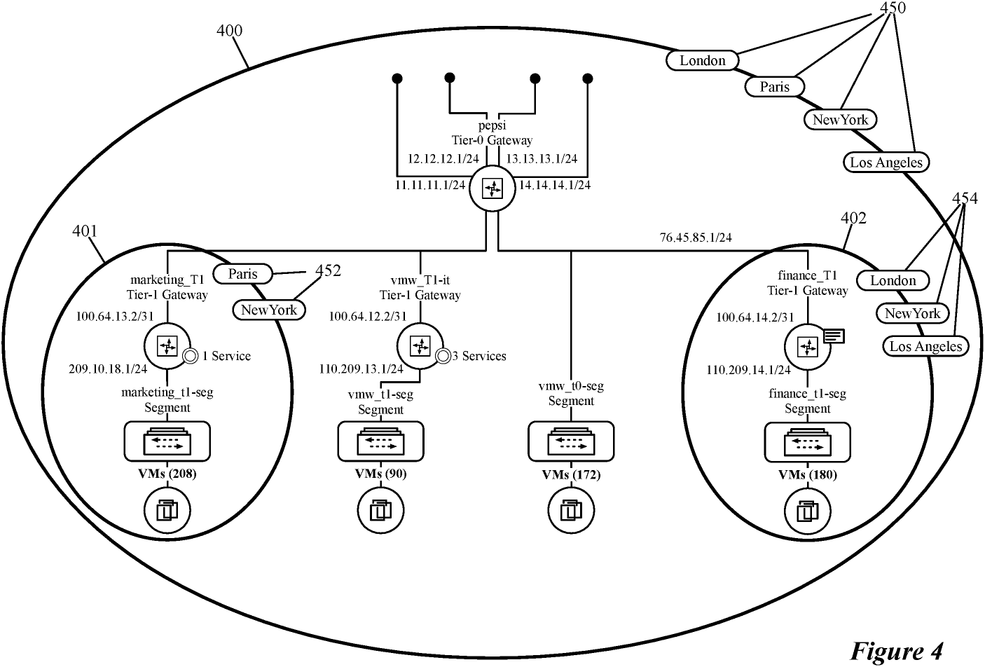

In some embodiments, more than one sub-portion of a logical network can span a different subset of sites, and each portion of the logical network spanning a different subset of sites may be represented within a different shape within a different UI item. FIG. 4 illustrates a visualization displayed through a UI, in some embodiments, of a representation of a logical network that includes two sub-tree spanning different subsets of the set of sites spanned by the rest of the logical network than the main portion of the logical network. As illustrated, the representation of the logical network 400 is encompassed by a first oval. A first set of badges 450 are applied to the edge of the first oval indicating that the logical network spans four sites—London, Paris, New York, and Los Angeles.

Within the first oval that encompasses the entire representation of the logical network 400, two sub-portions (i.e., sub-trees) of the logical network are shown to span different subsets of the set of four sites spanned by the logical network. The oval for sub-portion 401, which encompasses a logical switch that logically connects a group of 208 VMs to each other and to a tier-1 logical router, has two badges 452 applied to its border to indicate that this sub-portion spans only the Paris and New York sites. Similarly, the oval for another sub-portion 402, which encompasses a logical switch that logically connects a group of 180 VMs to each other and to a tier-1 logical router, has three badges 454 applied to its border to indicate that this sub-portion spans the London, New York, and Los Angeles sites.

As a result of the different sets and subsets of sites spanned by the different portions of the logical network 400, the site-specific topologies for each particular site would include different sets of logical elements. For instance, the site-specific topology for the New York site would include all of the logical elements represented in the representation of the logical network 400, whereas the site-specific topology for the Paris site would include all logical elements except for the logical elements within the sub-portion 402.

In some embodiments, if a second sub-portion of a first sub-portion of the logical network spans fewer sites than the subset of sites specified by the set of UI items applied to the first sub-portion, some embodiments represent this second sub-portion within a third shape with a third set of UI items specifying this smaller set of sites. If a logical network portion is fully isolated from the larger logical network, some embodiments treat this as a separate logical network that is separated in the UI visualization (or included in a separate UI visualization).

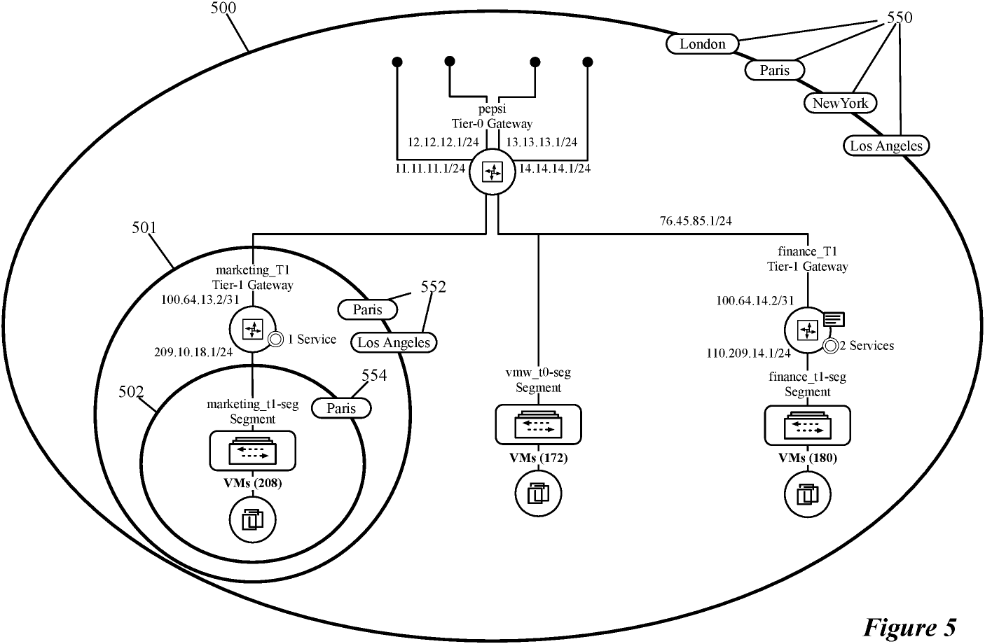

FIG. 5 illustrates a visualization displayed through a UI, in some embodiments, of a representation of a logical network that includes a second sub-portion within a first sub-portion of the logical network. The representation of the logical network 500 is encompassed by a first oval to which a set of badges 550 has been applied to indicate that this logical network spans four sites—London, Paris, New York, and Los Angeles. Within this first oval, a sub-portion of the logical network 501 is encompasses by a second, smaller oval to which a second set of badges 552 has been applied to indicate that this sub-portion 501 spans only the Paris and Los Angeles sites.

Unlike the other examples described above, a second sub-portion 502 is encompassed by a third, even smaller oval within the second oval. Additionally, a badge 554 has been applied to the edge of this third oval indicating this sub-sub-portion spans only the Paris site. As a result, if a user were to select one of the Los Angeles badges in order to view a representation of the site-specific topology for the Los Angeles site, the visualization would include all of the elements represented for the logical network 500 except the logical switch and group of VMs within the sub-sub-portion 502 as these elements only span the Paris site. Similarly, a selection of either the London or New York sites would cause the visualization to exclude all logical elements within the first sub-portion 501.

In some embodiments, a global network manager manages the global configuration for the logical network (e.g., receiving configuration data from administrators and defining the logical configuration for the network based on this configuration data), while local managers at each site spanned by the logical network manage local configurations for the sites. The global manager, in some embodiments, identifies the sites spanned by each logical network element and provides the logical configuration data for the network to the site. In addition, in some embodiments, the global manager uses this information to generate the logical network visualization. Global managers, local managers, and the operations they perform are also described in commonly owned U.S. Pat. Publication 2021/0314212, titled “Network Management System for Federated Multi-Site Logical Network, which is incorporated herein by reference in its entirety.

Administrators, in some embodiments, may define configurations for sites at the local manager level that differ from configurations defined at the global manager (i.e., modifying the configuration for a particular logical network element as implemented within that site). In this case, the local manager provides the global manager with a notification of this change. In such cases where the global configuration is overridden by an administrator at a local manager for a specific site, the visualization displayed through the UI includes a UI item (e.g., a badge icon) at a logical element associated with that specific site. When this UI item is selected (e.g., by mouse click, cursor hovering, etc.), in some embodiments, a pop-up window is displayed that provides additional information on the configuration differences at the specific site.

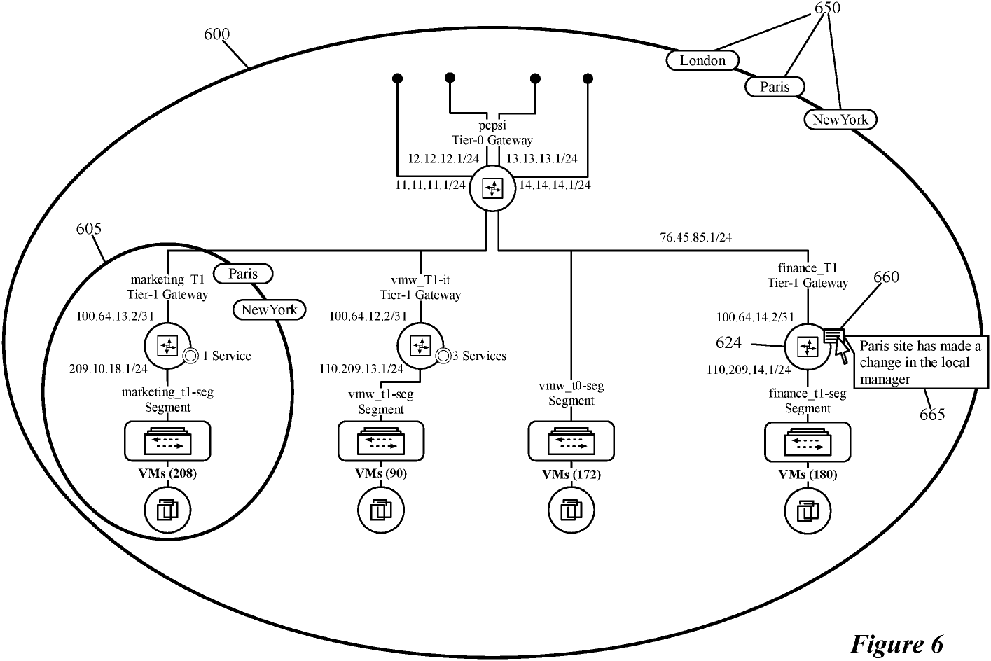

FIG. 6, for example, illustrates a visualization displayed through a UI of a representation of a logical network for which the configuration has been overridden at a local manager of a particular site, in some embodiments. As illustrated, the representation of the logical network 600 includes badges 650 indicating the logical network spans three sites—London, Paris, and New York. Additionally, the logical network 600 includes a sub-portion 605 that only spans the Paris and New York sites, as shown.

Unlike the examples described above, this representation of the logical network 600 shows a cursor selecting (e.g., via mouse click, hovering, etc.) a badge icon 660 on the tier-1 logical router 624, causing a pop-up 665 to be displayed. The badge icon 660 indicates a configuration change has been made at a local manager of a particular site for this portion of the logical network (i.e., the portion that includes all logical elements from the tier-1 logical router 624 down). As indicated by the pop-up 665, this configuration change has been made in the local manager of the Paris site. In some embodiments, the pop-up 665 appears when a cursor is hovered over the badge icon 660, and upon the badge icon 660 being selected via clicking, a different pop-up appears with further information regarding the changes indicated by the pop-up 665.

As mentioned above, in some embodiments, when the number of logical elements in a set of logical elements logically connected to a single logical element (e.g., a set of compute nodes connected to a logical switch) exceeds a threshold, a group node is used to represent the set of logical elements in the visualization. The group node, in some embodiments, includes a UI item that indicates the number of logical elements represented by the group node. As such, when a set of compute nodes (or multiple sets of compute nodes) that logically connect to the same logical switch, regardless of the site to which the compute nodes are local, the set of compute nodes are represented as a group node, in some embodiments.

In some embodiments, when the group node represents sets of compute nodes at multiple sites spanned by the logical switch to which the compute nodes connect, selecting the group node causes the UI to expand the group node in the visualization by separating the sets of compute nodes by the site at which each set of compute nodes is located. For instance, if a group node represents three sets of compute nodes located at three different sites, the expanded group node will include one group node, or group of individual nodes (i.e., when the number of compute nodes at a site does not meet the threshold for being represented as a group node), for each of the three sites. These site-specific group nodes can also be selected for further expansion (e.g., to display representations of individual compute nodes), according to some embodiments.

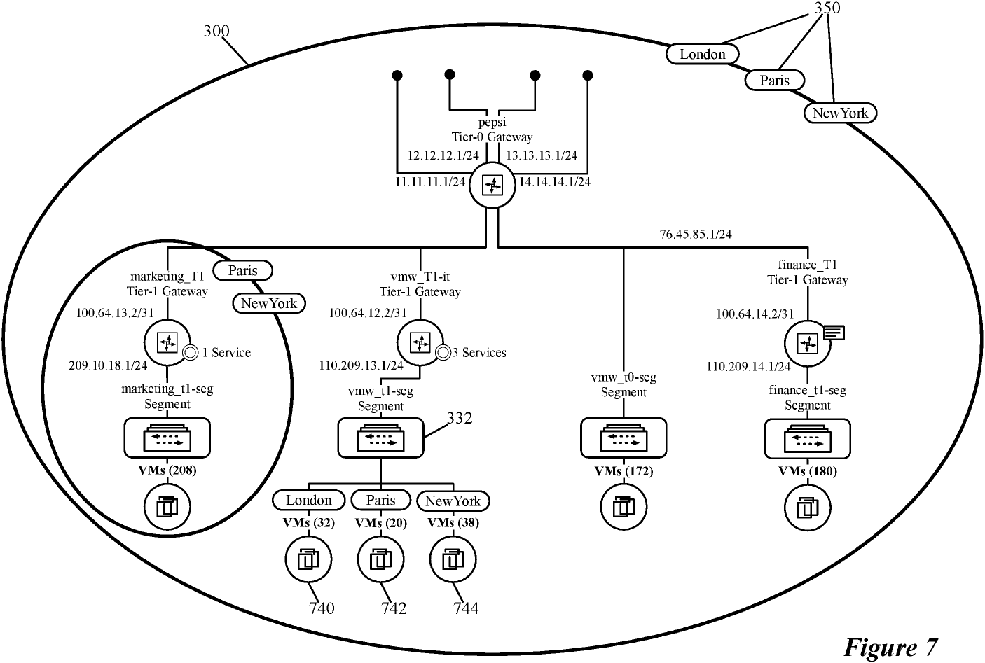

FIG. 7 illustrates a visualization displayed through a UI of a representation of the logical network 300 after the group node 342 representing the group of 90 VMs has been selected for expansion, in some embodiments. As shown, the expanded version of the group node 342 illustrated in FIG. 3 now includes three group nodes 740, 742, and 744. The group node 740 represents a group of 32 VMs local to the London site, the group node 742 represents a group of 20 VMs local to the Paris site, and the group node 744 represents a group of 38 VMs local to the New York site.

In some embodiments, each of the group nodes 740-744 can be selected for further expansion. The expanded versions of each of these group nodes would include individual nodes representing each VM in the group. That is, the expanded version of the group node 740 would include 32 individual nodes representing each of the 32 VMs local to the London site. Additionally, if a user were to select one of the badges 350 to view a site-specific topology, only the group node representing VMs for the selected site would be displayed. For instance, a selection to view the site-specific topology for the New York site would result in only the group node 744 representing the 38 VMs local to the New York site being displayed and having a logical connection to the logical switch 332.

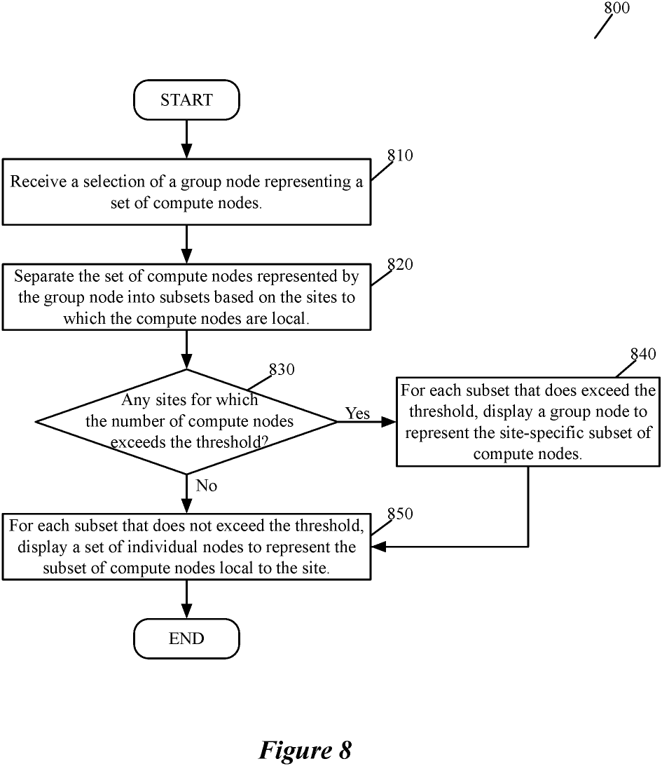

FIG. 8 illustrates a process performed by the network visualization application, in some embodiments, to display a visualization of a logical network topology after a group node representing VMs local to more than one site has been selected. The process 800 starts by receiving (at 810) a selection of a group node representing a set of compute nodes (e.g., VMs).

The process separates (at 820) the set of compute nodes represented by the group node into subsets based on the sites to which the compute nodes are local. For instance, the network visualization application would separate the VMs represented by the group node 342 in the example described above into three subsets, with one subset for each of the three sites spanned by the logical network 300.

The process determines (at 830) whether there are any sites for which the number of compute nodes local to that site exceeds a threshold number of compute nodes specified for requiring representation by a group node. In some embodiments, a group node is used to represent a set of VMs when there are at least five VMs in the set. Other embodiments may specify any number of logical elements as the threshold for representation by a group node.

When the process determines (at 830) that there are not any sites for which the number of compute nodes exceeds the specified threshold, the process transitions to display (at 850) each subset of compute nodes that does not exceed the threshold as a set of individual nodes representing each compute node in the subset. For example, if a group of eight compute nodes is separated into two subsets, with four compute nodes in each subset, the network visualization application would then display each compute node as an individual node, according to some embodiments.

When the process determines (at 830) that there are sites for which the number of compute nodes exceeds the specified threshold, the process transitions to display (at 840), for each subset that does exceed the threshold, a group node to represent the site-specific subset of compute nodes. For instance, the network visualization application displays the expanded version of the group node 342 as three group nodes 740-744, as described above. The process then transitions to display (at 850) any other subsets that do not exceed the threshold as sets of individual nodes, as mentioned above. Following 850, the process 800 ends.

In some embodiments, the logical connections between representations of logical forwarding elements (e.g., logical switches and gateway logical routers) are also selectable through the UI. These connections can include interfaces between a logical router that connects logical elements of the logical network to external networks and a logical router that connects groups of logical switches as well as between either type of logical router and a logical switch.

When a selection of such an interface is received, some embodiments display a pop-up window is displayed through the UI. This pop-up window includes representations of the pair of logical forwarding elements associated with the selected interface, as well as one link between the representations of these logical forwarding elements for each site spanned by these logical forwarding elements, according to some embodiments. Each link in the pop-up window is shown with network addresses involved on ports from each end of the link.

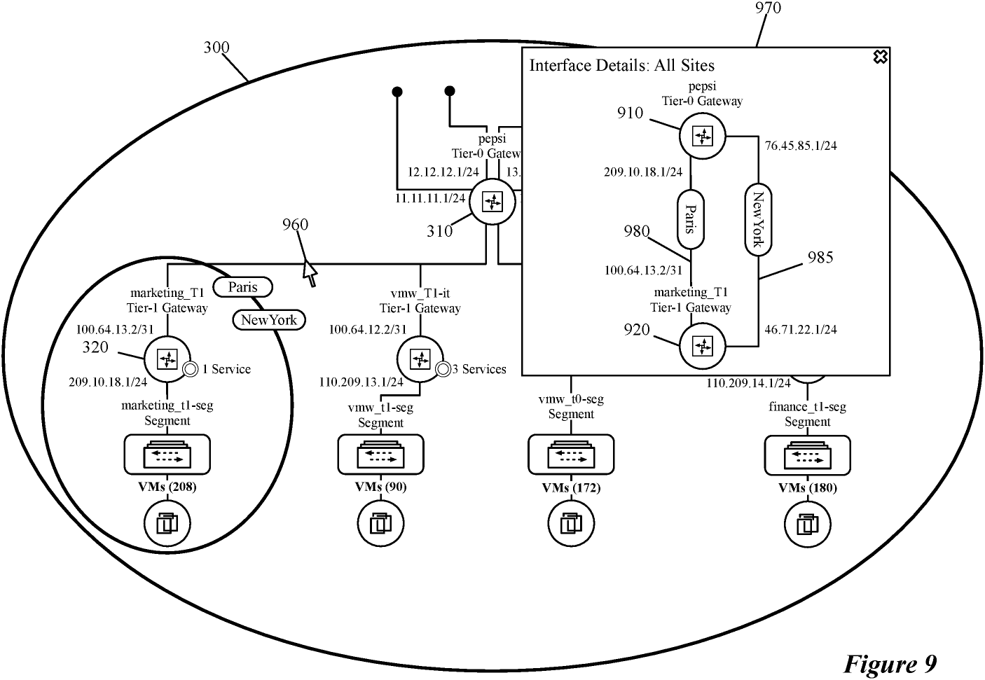

FIG. 9 illustrates a visualization displayed through a UI of the representation of the logical network 300 after an interface between two logical forwarding elements has been selected, in some embodiments. As illustrated by the cursor 960, the interface between the tier-1 logical router 320 and tier-0 logical router 310 has been selected, and a pop-up window 970 is now displayed through the UI.

The pop-up window 970 includes isolated representations of the tier-0 logical router 910 and tier-1 logical router 920, and two connection links 980 and 985 representing the connections for each of the two sites (Paris and New York) spanned by both logical routers. Because there are port IP addresses involved on each site whenever a logical router is connected to another logical router or a logical switch, these IP addresses are different for each site. As such, in order to provide greater visibility on all IP addresses from each of the different sites between two logical elements, the IP addresses involved on ports from each end of each link 980 and 985 are displayed in the pop-up window 970 alongside their corresponding links.

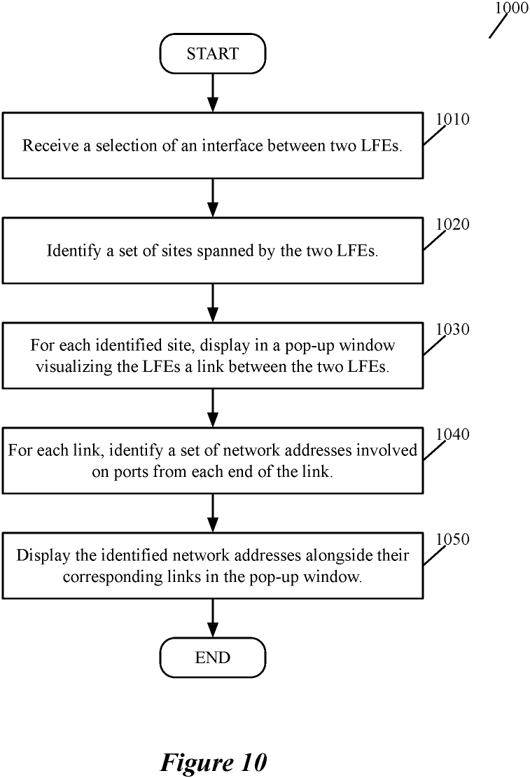

FIG. 10 illustrates a process performed by the network visualization application, in some embodiments, to display such a pop-up window 970 upon receiving selection of an interface between representations of two logical forwarding elements. The process 1000 starts by receiving (at 1010) a selection of an interface between two logical forwarding elements. For instance, in the example described above, the network visualization application received a selection of the interface between the tier-1 logical router 320 and tier-0 logical router 310.

The process identifies (at 1020) a set of sites spanned by the two logical forwarding elements. The tier-1 logical router 320 and tier-0 logical router 310, for example, both span the Paris and New York sites, as indicated by the badges 350 applied to the first oval encompassing the representation of the logical network 300, and further by the badges 355 applied to the second oval encompassing the sub-portion 305 that includes the tier-1 logical router 320. If a user were to select one of the interfaces between the tier-0 logical router 310 and either the tier-1 logical router 322 or tier-1 logical router 324, the identified sites would include all three of the London, Paris, and New York sites.

For each identified site, the process displays (at 1030) in a pop-up window visualizing the logical forwarding elements a link between the two logical forwarding elements. For instance, the pop-up window 970 includes representations of two links 980 and 985 between the isolated representations of the logical routers 910 and 920 in the example described above. The pop-up window displayed by the network visualization application can include as many links as there are sites spanned by the logical elements associated with the selected interface.

For each link, the process identifies (at 1040) a set of network addresses involved on ports from each end of the link. The process then displays (at 1050) the identified network addresses alongside their corresponding links in the pop-up window. As mentioned above, in order to provide greater visibility on all IP addresses from each of the different sites between two logical elements, the IP addresses involved on ports from each end of each link between the two logical elements are displayed in the pop-up window alongside their corresponding links. Following 1050, the process 1000 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

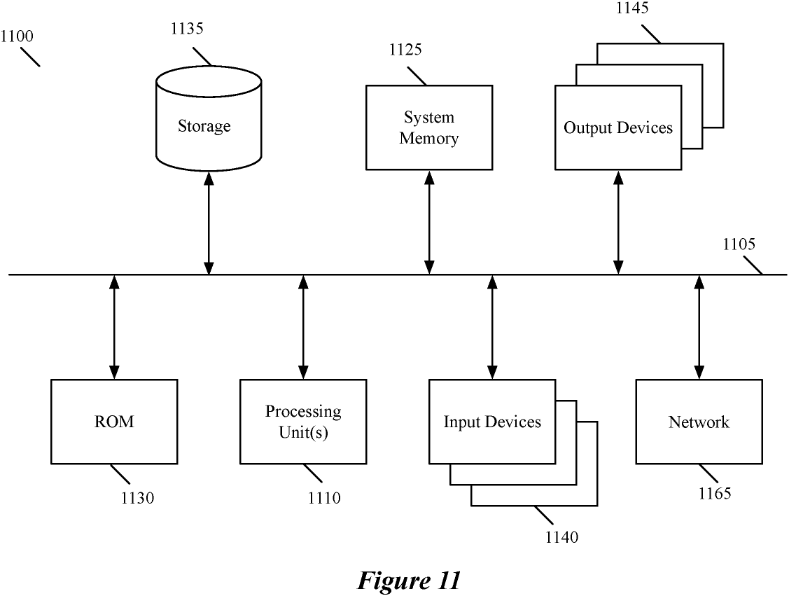

FIG. 11 conceptually illustrates a computer system 1100 with which some embodiments of the invention are implemented. The computer system 1100 can be used to implement any of the above-described hosts, controllers, gateway, and edge forwarding elements. As such, it can be used to execute any of the above described processes. This computer system 1100 includes various types of non-transitory machine-readable media and interfaces for various other types of machine-readable media. Computer system 1100 includes a bus 1105, processing unit(s) 1110, a system memory 1125, a read-only memory 1130, a permanent storage device 1135, input devices 1140, and output devices 1145.

The bus 1105 collectively represents all system, peripheral, and chipset buses that communicatively connect the numerous internal devices of the computer system 1100. For instance, the bus 1105 communicatively connects the processing unit(s) 1110 with the read-only memory 1130, the system memory 1125, and the permanent storage device 1135.

From these various memory units, the processing unit(s) 1110 retrieve instructions to execute and data to process in order to execute the processes of the invention. The processing unit(s) 1110 may be a single processor or a multi-core processor in different embodiments. The read-only-memory (ROM) 1130 stores static data and instructions that are needed by the processing unit(s) 1110 and other modules of the computer system 1100. The permanent storage device 1135, on the other hand, is a read-and-write memory device. This device 1135 is a non-volatile memory unit that stores instructions and data even when the computer system 1100 is off. Some embodiments of the invention use a mass-storage device (such as a magnetic or optical disk and its corresponding disk drive) as the permanent storage device 1135.

Other embodiments use a removable storage device (such as a floppy disk, flash drive, etc.) as the permanent storage device. Like the permanent storage device 1135, the system memory 1125 is a read-and-write memory device. However, unlike storage device 1135, the system memory 1125 is a volatile read-and-write memory, such as random access memory. The system memory 1125 stores some of the instructions and data that the processor needs at runtime. In some embodiments, the invention’s processes are stored in the system memory 1125, the permanent storage device 1135, and/or the read-only memory 1130. From these various memory units, the processing unit(s) 1110 retrieve instructions to execute and data to process in order to execute the processes of some embodiments.

The bus 1105 also connects to the input and output devices 1140 and 1145. The input devices 1140 enable the user to communicate information and select commands to the computer system 1100. The input devices 1140 include alphanumeric keyboards and pointing devices (also called “cursor control devices”). The output devices 1145 display images generated by the computer system 1100. The output devices 1145 include printers and display devices, such as cathode ray tubes (CRT) or liquid crystal displays (LCD). Some embodiments include devices such as touchscreens that function as both input and output devices 1140 and 1145.

Finally, as shown in FIG. 11, bus 1105 also couples computer system 1100 to a network 1165 through a network adapter (not shown). In this manner, the computer 1100 can be a part of a network of computers (such as a local area network (“LAN”), a wide area network (“WAN”), or an Intranet), or a network of networks (such as the Internet). Any or all components of computer system 1100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for presenting a visualization of a logical network that spans a plurality of geographically dispersed sites, the method comprising:
for each logical element in a set of logical elements of the logical network, identifying a set of sites spanned by the logical element; and
through a user interface (UI), displaying a visualization of a topology of the logical network, the visualization comprising (i) representations for the logical elements and for logical connections between the logical elements and (ii) at least a first set of UI items specifying each site of the plurality of sites spanned by the logical network to indicate, for each logical element represented in the visualization, the set of sites spanned by the logical element.

2. The method of claim 1, wherein the first set of UI items is applied to a representation of a first portion of the logical network that spans the plurality of sites, wherein a second set of UI items specifies each site of a subset of the plurality of sites and is applied to a representation of a second portion of the logical network that only spans the subset of sites.

3. The method of claim 2, wherein:
a first shape encloses a representation of the entire logical network and the first set of UI items are applied to the representation of the first portion of the logical network via the first shape; and
a second shape within the first shape encloses the representation of the second portion of the logical network and the second set of UI items are applied to the representation of the second portion via the second shape.

4. The method of claim 3, wherein the second portion of the logical network logically connects to at least one logical element within the first portion of the logical network.

5. The method of claim 1 further comprising:
receiving a selection of a particular UI item from the first set of UI items, the particular UI item corresponding to a particular site in the plurality of sites spanned by the logical network; and
based on the selection, displaying a visualization through the UI of a location-specific topology of the logical network for the particular site.

6. The method of claim 1, wherein:
the logical network is managed by a global manager;
each site in the plurality of sites is further managed by a respective local manager; and
a representation of a particular logical element in the visualization is displayed with an indicator UI item indicating a configuration change has been made at a local manager of a particular site spanned by the logical element.

7. The method of claim 6 further comprising:
receiving a selection of the indicator UI item; and
based on the received selection, displaying through the UI a pop-up window comprising information associated with the configuration change at the local manager of the particular site.

8. The method of claim 1, wherein:
the set of logical elements comprises gateway logical routers, logical switches, and compute nodes; and
the logical switches logically connect compute nodes to gateway logical routers.

9. The method of claim 8, wherein when a set of compute nodes that logically connect to a same logical switch exceeds a threshold number specified for compute nodes, the UI represents the set of compute nodes using a group node, the group node comprising a label denoting a number of compute nodes in the set represented by the group node.

10. The method of claim 9, wherein the group node is a first group node, the method further comprising:
receiving a selection of the first group node representing the set of compute nodes; and
based on the selection, displaying through the UI an expanded version of the first group node, the expanded version of the first group node comprising a set of group nodes, wherein each group node in the set of group nodes (i) represents a set of compute nodes at a particular site in a set of sites spanned by the logical switch to which the set of compute nodes logically connects and (ii) is displayed with a UI item specifying the particular site at which the set of compute nodes represented by the group node is located.

11. The method of claim 10 further comprising:
receiving a selection of a particular group node in the set of group nodes; and
based on the selection, displaying through the UI an expanded version of the particular group node, the expanded version of the particular group node comprising a set of individual nodes each representing a different compute node in the set of compute nodes represented by the particular group node.

12. The method of claim 1, wherein the logical elements comprise logical forwarding elements (LFEs), wherein representations of the logical connections between representations of LFEs are selectable through the UI, the method further comprising:
receiving a selection of a logical connection between a first LFE and a second LFE; and
based on the received selection, displaying through the UI a pop-up window comprising (i) representations of the first and second LFEs and (ii) one link between the first and second LFEs for each site spanned by the first and second LFEs, wherein each link is displayed with network addresses involved on ports from each end of the link.

13. The method of claim 12, wherein the first LFE is a gateway logical router that connects logical elements of the logical network to external networks and the second LFE is a gateway logical router that connects groups of logical switches.

14. The method of claim 12, wherein the first LFE is a gateway logical router that connects logical elements of the logical network to external networks and the second LFE is a logical switch that logically connects compute nodes to each other and to the gateway logical router.

15. The method of claim 12, wherein the first LFE is a gateway logical router that connects groups of logical switches and the second LFE is a logical switch that logically connects compute nodes to each other and to the gateway logical router.

16. A non-transitory machine-readable medium storing a program which when executed by at least one processing unit presents a visualization of a logical network that spans multiple geographically dispersed sites, the program comprising sets of instructions for:
identifying, for each logical element in a set of logical elements of the logical network, a set of sites spanned by the logical element; and
displaying through a user interface (UI), a visualization of a topology of the logical network, the visualization comprising (i) representations for the logical elements and for logical connections between the logical elements and (ii) at least a first set of UI items specifying each site of the plurality of sites spanned by the logical network to indicate, for each logical element represented in the visualization, the set of sites spanned by the logical element.

17. The non-transitory machine-readable medium of claim 16, wherein the first set of UI items is applied to a representation of a first portion of the logical network that spans the plurality of sites, wherein a second set of UI items specifies each site of a subset of the plurality of sites and is applied to a representation of a second portion of the logical network that only spans the subset of sites.

18. The non-transitory machine-readable medium of claim 17, wherein:
a first shape encloses a representation of the entire logical network and the first set of UI items are applied to the representation of the first portion of the logical network via the first shape;
a second shape within the first shape encloses the representation of the second portion of the logical network and the second set of UI items are applied to the representation of the second portion via the second shape; and
the second portion of the logical network logically connects to at least one logical element within the first portion of the logical network.

19. The non-transitory machine-readable medium of claim 16, wherein the program further comprises sets of instructions for:
receiving a selection of a particular UI item from the first set of UI items, the particular UI item corresponding to a particular site in the plurality of sites spanned by the logical network; and
based on the selection, displaying a visualization through the UI of a location-specific topology of the logical network for the particular site.

20. The non-transitory machine-readable medium of claim 16, wherein:
the logical network is managed by a global manager;
each site in the plurality of sites is further managed by a respective local manager;
a representation of a particular logical element in the visualization is displayed with an indicator UI item indicating a configuration change has been made at a local manager of a particular site spanned by the logical element; and
the program further comprises sets of instructions for:
receiving a selection of the indicator UI item; and
based on the received selection, displaying through the UI a pop-up window comprising information associated with the configuration change at the local manager of the particular site.

21. The non-transitory machine-readable medium of claim 16, wherein the logical elements comprise logical forwarding elements (LFEs), wherein representations of the logical connections between representations of LFEs are selectable through the UI, the program further comprising sets of instructions for:
receiving a selection of a logical connection between a first LFE and a second LFE; and
based on the received selection, displaying through the UI a pop-up window comprising (i) representations of the first and second LFEs and (ii) one link between the first and second LFEs for each site spanned by the first and second LFEs, wherein each link is displayed with network addresses involved on ports from each end of the link.

22. An electronic device comprising:
a set of one or more processing units; and
a non-transitory machine-readable medium storing a program which when executed by at least one of the processing units presents a visualization of a logical network that spans multiple geographically dispersed sites, the program comprising sets of instructions for:
identifying, for each logical element in a set of logical elements of the logical network, a set of sites spanned by the logical element; and
displaying through a user interface (UI), a visualization of a topology of the logical network, the visualization comprising (i) representations for the logical elements and for logical connections between the logical elements and (ii) at least a first set of UI items specifying each site of the plurality of sites spanned by the logical network to indicate, for each logical element represented in the visualization, the set of sites spanned by the logical element.
